(19) United States
(12) Patent Application Publication
(10) Pub. No.: US 2019/0037824 A1
(43) Pub. Date: Feb. 7, 2019

(54) FISHING LURE CONTAINER DEVICE AND METHOD

(71) Applicant: Matthew Rollins, Las Vegas, NV (US)

(72) Inventor: Matthew Rollins, Las Vegas, NV (US)

(21) Appl. No.: 16/053,709

(22) Filed: Aug. 2, 2018

Related U.S. Application Data
(60) Provisional application No. 62/540,351, filed on Aug. 2, 2017.

(51) Int. Cl. A01K 97/04; A01K 83/04; B65D 83/00; B65D 25/38

(52) U.S. Cl. CPC A01K 97/04; B65D 25/38; B65D 83/0055; A01K 83/04

(57) ABSTRACT

A fishing lure container device includes a hollow unitary enclosure having a cylindrical portion and a conical portion. The cylindrical portion includes a receiving end and the conical portion includes an attachment end at its apex. The hollow enclosure further defines an inner volume. The cylindrical portion includes a storage aperture slit configured across the diameter of the receiving end. The apex of the conical portion includes an attachment hook affixed to the attachment end of the conical portion. The unitary enclosure of the fishing lure container device comprises a manually deformable material. The storage aperture slit is configured to expand for receiving a fishing lure when manually deformed. The fishing lure container device is useful for retaining a fishing lure while the fishing lure is still attached to a fishing line.

### CROSS-REFERENCE TO RELATED APPLICATION(S)

The present application is related to and claims priority to U.S. Provisional Patent Application No. 62/540,351 filed Aug. 2, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of containers of existing art and more specifically relates to containers for fishing lures.

### RELATED ART

Typically, a person who is fishing must change their fishing lure multiple times in a single session. Often fishing lures are snagged on a stationary object under water and are unable to be easily retrieved. A person who is fishing moves from one location to the next throughout the course of a fishing expedition. The person may have to traverse through rough terrain which snags the fishing hook and causes problems. Many fishermen choose to hang their hooks on the rod and tighten the line attached to the hook such that the hook remains in place on the rod. This method of transporting a fishing hook attached to a fishing line includes tightening the drag resistance on the reel, which may be at an optimal setting. A suitable means for transporting is desired.

U.S. Pat. No. 4,936,040 to Ronald J. Reiter relates to a lure container. The described lure container includes a container for holding and protecting a fishing lure attached to the line of a fishing rod that comprises a unitary envelope of rubber-like material. The envelope has an elongated rectangular body with pyramidal end regions. A normally closed slit in one face of the envelope extends from the apex of one end region to the apex of the other end region. When the ends of the container are squeezed toward each other, the slit opens providing a generally rectangular opening for the length of the container. An opening in the apex of one end region allows the line to pass out of the container. A hook on the container enables it to be attached to one of the line guide rings on the rod.

### SUMMARY OF THE INVENTION

In view of the foregoing disadvantages inherent in the known containers for fishing lures art, the present disclosure provides a novel fishing lure container device. The general purpose of the present disclosure, which will be described subsequently in greater detail, is to provide an effective and efficient fishing lure container device.

A fishing lure container device is disclosed herein. The fishing lure container device includes a hollow unitary enclosure having a cylindrical portion and a conical portion. The cylindrical portion includes a receiving end and the conical portion includes an attachment end at its apex. The hollow unitary enclosure further defines an inner volume. The cylindrical portion includes a storage aperture slit configured across the diameter of the receiving end. The apex of the conical portion includes an attachment hook fixed to the attachment end at the apex of the conical portion. The unitary enclosure of the fishing lure container comprises a manually deformable material. The storage aperture slit is configured to expand for receiving a fishing lure when manually deformed about the cylindrical portion, thereby exposing the inner volume.

According to another embodiment, a method for using a fishing lure container device for storing a fishing lure is also disclosed herein. The method for using a fishing lure container device for storing a fishing lure includes providing a fishing lure container device; the device including a hollow unitary enclosure having a cylindrical portion and a conical portion; the cylindrical portion including a receiving end; the conical portion including an attachment end at the apex of the conical portion. The hollow enclosure further defining an inner volume, a storage aperture slit configured across the diameter of the receiving end, and an attachment hook affixed to the attachment end of the conical portion, applying manual pressure about the cylindrical portion to reconfigure the storage aperture slit in an open position for receiving the fishing lure, and releasing manual pressure applied to the cylindrical portion after the fishing lure has been positioned within the inner volume. Further steps may include removing the attachment hook from the fishing rod and applying the manual pressure about the cylindrical portion to reconfigure the storage aperture slit in an open position for releasing the fishing lure contained therein.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing lure container, constructed and operative according to the teachings of the present disclosure.

FIG. 1 is a perspective view of the fishing lure container device for storing a fishing lure during an ‘in-use’ condition, according to an embodiment of the disclosure.

FIG. 2 is a partially cut away perspective view of the fishing lure container device for storing a fishing lure of FIG. 1, according to an embodiment of the present disclosure.

FIG. 3 is a perspective view of the fishing lure container device for storing a fishing lure of FIG. 1, according to an embodiment of the present disclosure.

FIG. 4 is a deformed view of the fishing lure container device for storing a fishing lure of FIG. 1, according to an embodiment of the present disclosure.

FIG. 5 is a flow diagram illustrating a method of use for storing a fishing lure while attached to a fishing line, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to flexible containers for fishing lures and more particularly to a fishing lure container device as used to improve the retainment of fishing lures.

Generally speaking, the fishing lure container device disclosed herein comprises a substantially opaque hollow unitary enclosure having a cylindrical portion and a conical portion; wherein the cylindrical portion may have a larger volume than the conical portion. The cylindrical portion includes a receiving end and the conical portion includes an attachment end at its apex. The hollow enclosure further defines an inner volume. The inner volume may be at least fifty cubic inches. The cylindrical portion includes a storage aperture slit configured across the diameter of the receiving end. The storage aperture slit may further comprise a guide hole configured for a fishing line to pass through while the storage aperture slit is closed. The storage aperture slit may be configured to frictionally retain the fishing lure within the hollow unitary enclosure while the fishing lure remains attached to the fishing line. The apex of the conical portion includes an attachment hook fixed to the attachment end of the conical portion.

The attachment hook may be configured for tensional coupling to a fishing rod and alternatively a fishing reel; wherein the attachment hook may have a J-shape and may comprise plastic or a composite thereof. In one embodiment, the attachment hook may also be configured as a strap that extends through an aperture in the attachment end of the device. In another preferred embodiment, the device may include at least one mounting post on the back of the device, wherein the mounting post may be configured to couple with a secondary attachment means. The secondary attachment means may include a rope, elastic band, strap, or hook and loop fastener. The unitary enclosure of the fishing lure container device for storing a fishing lure comprises a manually deformable material. The manually deformable material is configured to return to its original shape once manual pressure has been removed. The storage aperture slit may be configured to widen when the cylindrical portion is manually deformed, thereby exposing the inner volume. The material of the fishing lure container may comprise rubber or a composite thereof. The fishing lure container device may weigh less than 1 lb in preferred embodiments.

In a preferred embodiment, the fishing lure container device may include a raised clip or frictional attachment channel for removably coupling the device to the shaft of a fishing pole. The frictional attachment channel may include a pair of raised edges running down the long axis of the device, wherein the raised edges may be configured to removably clip around the shaft of a fishing rod. The device body, including the attachment channel, may be structured and arranged with flexible materials that allow for repeated coupling to a variety of fishing rod shapes, sizes, and dimensions.

In yet another preferred embodiment, the fishing lure container device may include an external loop with a clip configured for easy and secure transport of the device. The included clip may be configured as a keychain ring, carabiner-type spring clip, or other removable assembly which may be useful for non-permanent attachment to a belt loop, key ring, travel case, backpack, or other item.

Upon reading this specification, it should be appreciated that, under appropriate circumstances, considering such issues as user preferences, design preference, structural requirements, marketing preferences, cost, available materials, technological advances, etc., other fishing lure container device arrangements such as, for example, a device having a larger inner volume or alternative clips for coupling with salt water fishing rods, etc., may be sufficient.

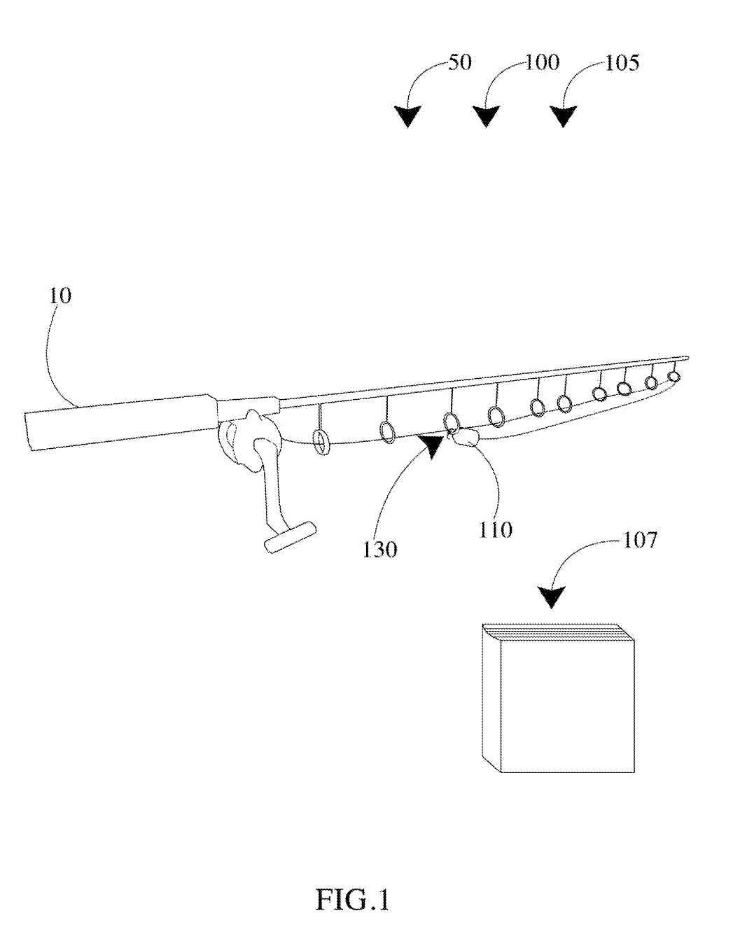

Referring now more specifically to the drawings by numerals of reference, there is shown in FIGS. 1-4, various views of a fishing lure container device for storing a fishing lure 100.

FIG. 1 shows a fishing lure container device 100 during an ‘in-use’ condition 50, according to an embodiment of the present disclosure. Here, the fishing lure container device may be beneficial for use by a user 40 to retaining a fishing hook. As illustrated, the fishing lure container device 100 may include a hollow unitary enclosure 110 having an attachment hook 130 for attaching to a fishing rod 10.

According to one embodiment, the fishing lure container device 100 may be arranged as a kit 105. In particular, the fishing lure container device 100 may further include a set of instructions 107. The instructions 107 may detail functional relationships in relation to the structure of the fishing lure container device 100 such that the fishing lure container device 100 can be used, maintained, or the like, in a preferred manner.

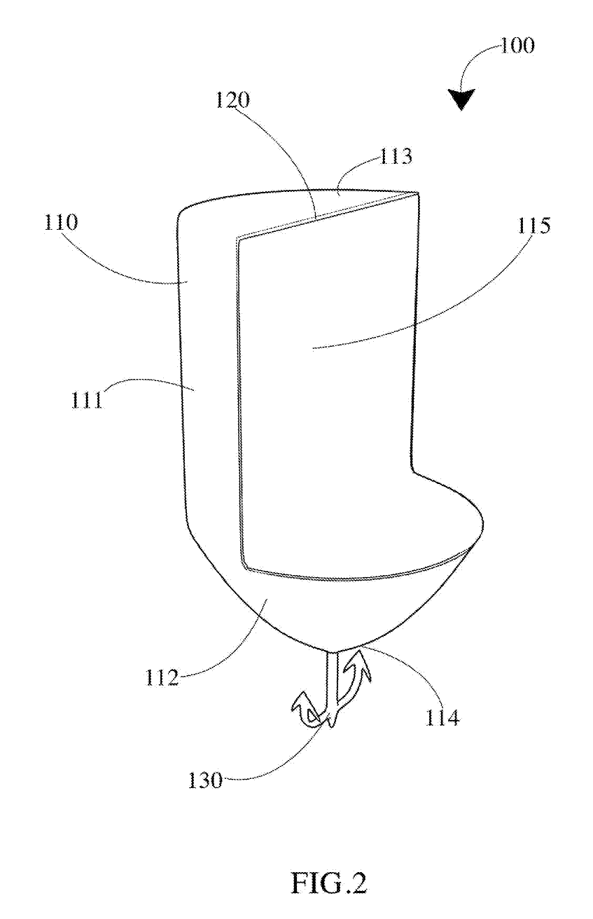

FIG. 2 illustrates a partially cutaway view of the fishing lure container device 100 of FIG. 1, according to an embodiment of the present disclosure. As above, the fishing lure container device 100 may comprise a hollow unitary enclosure 110 having an inner volume 115. The hollow unitary enclosure 110 comprises a cylindrical portion 111 and a conical portion 112. The cylindrical portion 111 includes a receiving end 113 having a storage aperture slit 120 across the diameter of the receiving end 111. The aperture slit 120 gives access to the inner volume 115 of the hollow unitary enclosure 110. The attachment end 114 of the conical portion 112 may have an attachment hook 130 affixed on the apex of the conical portion 112.

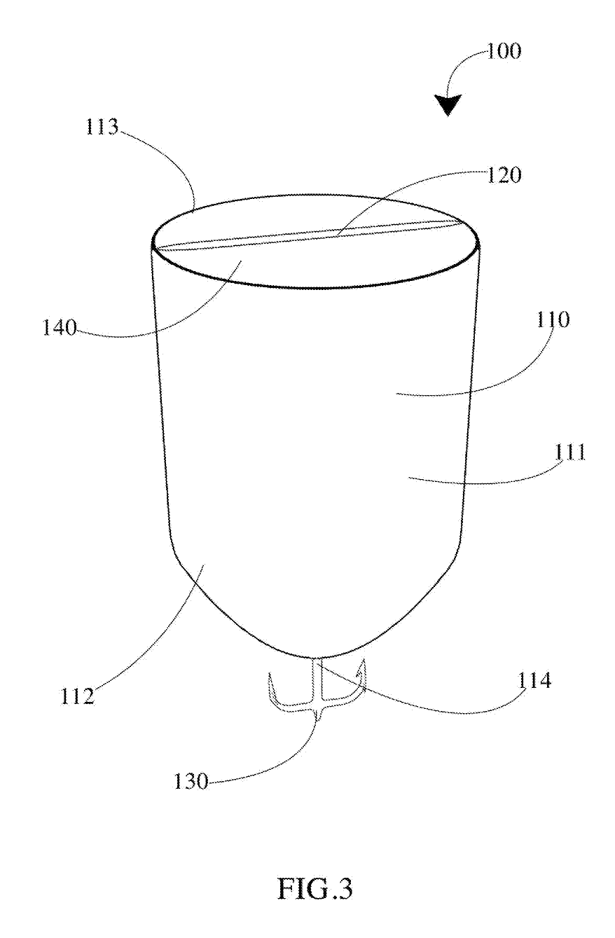

FIG. 3 is a perspective view of the fishing lure container device 100 of FIG. 1, according to an embodiment of the present disclosure. Here the fishing lure container device 100 is illustrated showing the conical portion 112 and the cylindrical portion 111 forming a hollow unitary enclosure. The fishing lure container devices 100 comprises entirely of a manually deformable material 140. The storage aperture slit 120 on the receiving end 113 is configured to to give access to the hollow unitary enclosure 110 widen when the cylindrical portion 111 is manually deformed. FIG. 3 further illustrates an attachment hook 130 affixed to the attachment end 114 of the conical portion 112.

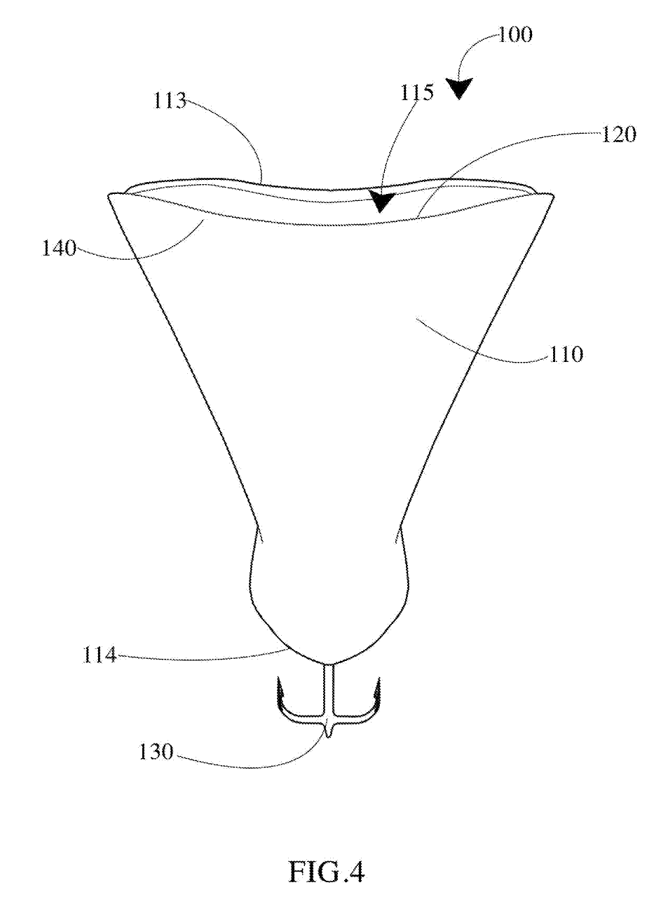

FIG. 4 is a deformed view of the fishing lure container device 100 of FIG. 1, according to an embodiment of the present disclosure. In this illustration the manually deformable material 140 of the fishing lure container device 100 has been deformed. The cylindrical portion 111 has been manually deformed through a force normal to the cylindrical portion 111. The deformation has caused the storage aperture slit 120 on the receiving end 113 to widen which exposes the inner volume 115.

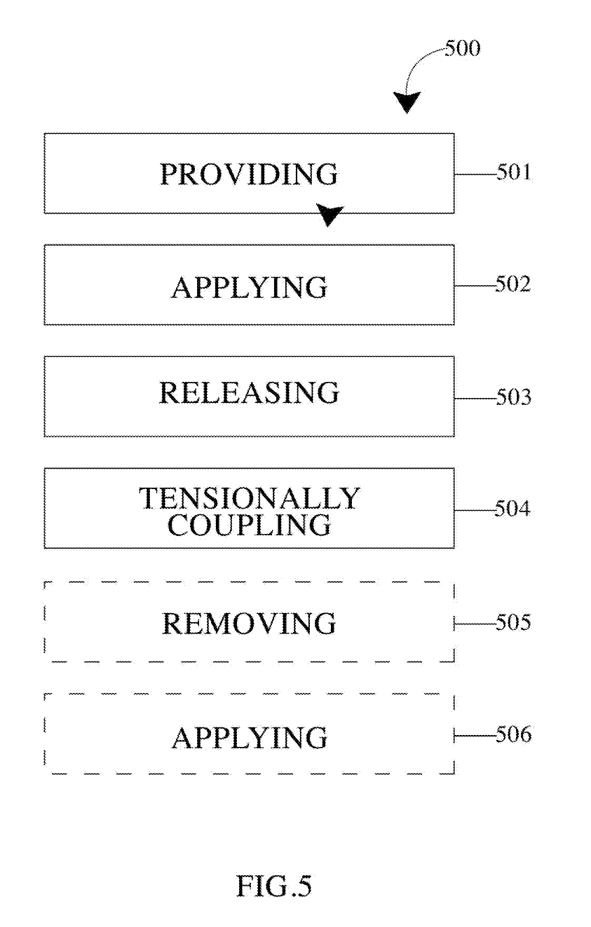

FIG. 5 is a flow diagram illustrating a method for storing 500 a fishing lure while attached to a fishing line, according to an embodiment of the present disclosure. In particular, the method for storing a fishing lure while attached to a fishing line 500 may include one or more components or features of the fishing lure container device 100 as described above. As illustrated, the method for storing a fishing lure 500 may include the steps of: step one 501, providing a fishing lure container device 100, the fishing lure device 100 including a hollow unitary enclosure 110 having a cylindrical portion 111 and a conical portion 112, the cylindrical portion 111 including a receiving end 113, the conical portion 112 including an attachment end 114 at the apex of the conical portion 112, the hollow unitary enclosure 110 further defining an inner volume 115, a storage aperture slit 120 configured across the diameter of the receiving end 113, an attachment hook 130 is affixed to the attachment end 114 of the conical portion 112, wherein the hollow unitary enclosure 110 comprises a manually deformable material 140, wherein the storage aperture slit 120 is configured to expand for receiving a fishing lure when manually deformed about the cylindrical portion 111, thereby exposing the inner volume 115; step two 502, applying manual pressure about the cylindrical portion 111 to reconfigure the storage aperture slit 120 in an open position for receiving the fishing lure; step three 503, releasing manual pressure applied to the cylindrical portion 111 after the fishing lure has been positioned within the inner volume 115; step four 504, tensionally coupling the attachment hook 130 to the fishing rod 10; step five 505, removing the attachment hook 130 from the fishing rod 10; step six 506, applying the manual pressure about the cylindrical portion 111 to reconfigure the storage aperture slit 120 in an open state.

It should be noted that step 505 and 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for storing a fishing lure while attached to a fishing line are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fishing lure container device for storing a fishing lure, the fishing lure container device comprising:
a hollow unitary enclosure having a cylindrical portion and a conical portion, the cylindrical portion including a receiving end, the conical portion including an attachment end at an apex of the conical portion, the hollow enclosure further defining an inner volume;
a storage aperture slit configured across a diameter of the receiving end; and,
an attachment hook fixed to the attachment end of the conical portion;
wherein the hollow unitary enclosure comprises a manually deformable material; and,
wherein the storage aperture slit is configured to expand for receiving a fishing lure when manually deformed about the cylindrical portion, thereby exposing the inner volume.

2. The fishing lure container device of claim 1, wherein the manually deformable material is configured to return to its original shape once manual pressure has been removed.

3. The fishing lure container device of claim 2, wherein the manually deformable material comprises plastic.

4. The fishing lure container device of claim 2, wherein the manually deformable material comprises rubber.

5. The fishing lure container device of claim 1, wherein the inner volume is at least 50 cubic inches.

6. The fishing lure container device of claim 1, wherein the attachment hook comprises plastic.

7. The fishing lure container device of claim 1, wherein the cylindrical portion is larger than the conical portion.

8. The fishing lure container device of claim 1, wherein the hollow unitary enclosure is substantially opaque.

9. The fishing lure container device of claim 1, wherein the storage aperture slit is configured to allow a fishing line to pass through while the storage aperture slit is substantially closed.

10. The fishing lure container device of claim 1, wherein the storage aperture slit is configured to frictionally retain the fishing lure while the fishing lure remains attached to the fishing line.

11. The fishing lure container device of claim 1, wherein the attachment hook comprises a J-shape.

12. The fishing lure container device of claim 1, wherein the attachment hook comprises a V-shape.

13. The fishing lure container device of claim 1, wherein the attachment hook is configured for tensional coupling to a fishing rod.

14. The fishing lure container device of claim 1, wherein the attachment hook is configured for tensional coupling to a fishing reel.

15. The fishing lure container device of claim 1, wherein the storage aperture slit further comprises a guide hole in the center of the storage aperture slit, the guide hole configured to receive the fishing line.

16. The fishing lure container device of claim 1, wherein the device weighs less than 1 lb.

17. A fishing lure container device, the device comprising:
a hollow unitary enclosure having a cylindrical portion and a conical portion, the cylindrical portion including a receiving end, the conical portion including an attachment end at an apex of the conical portion, the hollow enclosure further defining an inner volume;
a storage aperture slit configured across a diameter of the receiving end; and,
an attachment hook fixed to the attachment end of the conical portion;
wherein the hollow unitary enclosure comprises a manually deformable material;
wherein the storage aperture slit is configured to expand for receiving a fishing lure when manually deformed about the cylindrical portion, thereby exposing the inner volume;
wherein the manually deformable material is configured to return to its original shape once manual pressure has been removed;
wherein the manually deformable material comprises rubber;
wherein the inner volume is at least 50 cubic inches;
wherein the attachment hook comprises plastic;
wherein the cylindrical portion is larger than the conical portion;
wherein the hollow unitary enclosure is substantially opaque;
wherein the storage aperture slit is configured to allow a fishing line to pass through while the storage aperture slit is substantially closed;
wherein the storage aperture slit is configured to frictionally retain the fishing lure while the fishing lure remains attached to the fishing line;
wherein the attachment hook comprises a J-shape;
wherein the attachment hook is configured for tensional coupling to a fishing rod;
wherein the attachment hook is configured for tensional coupling to a fishing reel;
wherein the storage aperture slit further comprises a guide hole in the center of the storage aperture slit, the guide hole configured to receive the fishing line; and
wherein the device weighs less than 1 lb.

18. The fishing lure container device of claim 17, further comprising set of instructions; and
wherein the device is arranged as a kit.

19. A method for using a fishing lure container device on a fishing lure that is attached to a fishing line of a fishing rod, the method comprising the steps of:
providing a fishing lure container device, the device including a hollow unitary enclosure having a cylindrical portion and a conical portion, the cylindrical portion including a receiving end, the conical portion including an attachment end at the apex of the conical portion, the hollow enclosure further defining an inner volume, a storage aperture slit configured across the diameter of the receiving end, and an attachment hook fixed to the attachment end of the conical portion;
applying manual pressure about the cylindrical portion to reconfigure the storage aperture slit in an open position for receiving the fishing lure;
releasing manual pressure applied to the cylindrical portion after the fishing lure has been positioned within the inner volume; and
tensionally coupling the attachment hook to the fishing rod.

20. The method of claim 19, further comprising the steps of:
removing the attachment hook from the fishing rod; and
applying the manual pressure about the cylindrical portion to reconfigure the storage aperture slit in an open state.
